(19) United States
(12) Patent Application Publication
(10) Pub. No.: US 2025/0369460 A1
(43) Pub. Date: Dec. 4, 2025

(54) Hydraulic Drive System

(71) Applicant: HMS--Hybrid Motion Solutions GmbH, Rutesheim (DE)

(72) Inventors: Achim HELBIG, Stuttgart (DE); Frank SOEHNEL, Stuttgart (DE); Simon JANOSCH, Pforzheim (DE)

(21) Appl. No.: 19/220,144

(22) Filed: May 28, 2025

(30) Foreign Application Priority Data
May 29, 2024 (DE) 102024115108.0

(51) Int. Cl. F15B 21/00; F15B 21/044

(52) U.S. Cl. CPC F15B 21/005; F15B 21/044

(57) ABSTRACT

The invention relates to a method for filling and venting hydraulic systems (12) by means of a hydraulic fluid (14), comprising the steps of: degassing the hydraulic fluid (14) by applying a vacuum; filling the hydraulic system (12) with the degassed hydraulic fluid (14).

The invention relates to a method for filling and venting hydraulic systems. The invention further relates correspondingly to a use, a device and a system for filling and venting hydraulic systems.

Open, semi-open and closed hydraulic systems are known from the prior art. Semi-open and closed hydraulic systems are associated with reduced accessibility to the hydraulic fluid. During setup, when replacing components and at regular intervals, the hydraulic fluid, such as hydraulic oil, is added to the hydraulic system. In hydraulic systems, in particular drive systems for linear axes or braking systems for vehicles, the hydraulic fluid is used for force and power transmission. The hydraulic fluid is only slightly compressible, which allows for good power transmission with low losses.

Normally, an empty hydraulic system is filled by connecting devices to both ends of the hydraulic system to enable the filling process. At one end a hydraulic fluid is supplied and at the other end air is discharged. The filling process can be supported by overpressure during supplying and negative pressure during discharge.

It is important to properly fill and also vent hydraulic systems with the hydraulic fluid each time they are put into operation, when components are replaced, or during maintenance. If undissolved and freely moving air remains in the hydraulic system, even in the smallest quantities, the ability of the hydraulic fluid to transmit power is reduced. The reason for this is that, unlike hydraulic fluid, air is compressible. This means that power is lost due to the compression of the air.

During the entire filling process, there is air in the hydraulic system, which must be displaced by the inflow of hydraulic fluid. However, this can only be achieved to the extent that the air is able to leave the hydraulic system through an opening. However, the opening is often not located at the highest point of the hydraulic system, or there are various points within the hydraulic system where air pockets can form, since the air always rises to the highest point and from there has no way to escape from the system.

In such case, ventilation can be improved by rotating the hydraulic system so that the highest points to which the freely moving air rises can be changed. In complex circuits, even this does not ensure that all air can be removed from the hydraulic system. Furthermore, rotation of the hydraulic system is often not possible at all or involves a great deal of effort and long downtimes.

The invention is based on the object of providing a method for filling hydraulic systems with a hydraulic fluid, during which the hydraulic system is reliably vented.

The object achieved by the invention is likewise achieved by a method having the features of claim 1. The invention is directed to a method for filling and venting hydraulic systems by means of a hydraulic fluid, in particular mineral oil-based hydraulic fluid, comprising the steps of: degassing the hydraulic fluid by applying a vacuum; filling the hydraulic system with the degassed hydraulic fluid.

Degassing the hydraulic fluid under vacuum is a suitable preparation measure for the hydraulic fluid. The hydraulic system can be filled particularly easily using the hydraulic fluid. This also results in a significantly higher venting quality.

It is advantageous if the method further comprises the step of: venting the hydraulic system by absorbing the air that is freely moving in the hydraulic system using the degassed hydraulic fluid.

Hydraulic fluids, such as hydraulic oils, have approximately 8 vol. % dissolved air under atmospheric conditions. By degassing the hydraulic fluid in a vacuum, air is removed from the hydraulic fluid, which reduces the air saturation in the hydraulic fluid. The vented hydraulic fluid is thus capable of absorbing, dissolving and binding freely moving air. This is used to absorb the freely moving air present in the hydraulic system, which has not been expelled by the venting known from the prior art. The air is still present in the hydraulic system, but no longer in the form of freely moving air, which impairs operation, but is dissolved in the hydraulic fluid. The method can therefore ensure that no freely moving air remains in the hydraulic system once the hydraulic fluid has been filled in. This results in lower power losses and greater process reliability when operating the hydraulic system. Furthermore, the downtime of the hydraulic system can be significantly reduced. The very low compressibility of the fluid remains. Undissolved air in the system would lead to significant losses in compressibility, oil aging, cavitation of hydraulic components and thus to wear.

It is advantageous if the method further comprises the following step, in particular before filling according to step b): emptying waste fluid from the hydraulic system, preferably suctioning waste fluid from the hydraulic system, and/or evacuating the hydraulic system by applying a vacuum. Accordingly, the removal of the waste fluid can be improved. Waste fluid is the hydraulic fluid that is in the hydraulic system before the degassed hydraulic fluid is filled in. Moreover, evacuation can remove a significant portion of the freely moving air in the hydraulic system.

An advantageous aspect of the invention provides for the emptying of waste fluid according to step d) to be carried out by applying a vacuum in such a way that a maximum of 7 vol. %, in particular a maximum of 6 vol. %, preferably a maximum of 5 vol. %, preferably a maximum of 4 vol. %, of freely moving air remains in the hydraulic system. This results in that the air freely moving in the hydraulic system does not exceed a maximum limit. This ensures that the degassed hydraulic fluid can absorb the freely moving air in the hydraulic system.

An advantageous aspect of the invention provides for the hydraulic system to be designed to be open, semi-open or closed. The more restricted access to the hydraulic system is, the more difficult it is to vent. In a closed hydraulic system, the hydraulic fluid is not in fluidic communication with the atmosphere. In a semi-open hydraulic system, the leakage fluid line is fluidically connected to a fluid tank, wherein the fluid tank is exposed to the atmosphere. However, the leakage fluid line is dimensioned so small compared to the drive lines that no significant venting takes place via the leakage fluid line.

An advantageous aspect of the invention provides for the hydraulic fluid to be circulated by means of a circulation device, in particular a propeller, during degassing according to step a). To further improve and accelerate degassing of the hydraulic fluid, the hydraulic fluid must be set in motion. This leads to the formation of nucleation sites where air bubbles can form. These air bubbles are removed from the hydraulic fluid by the vacuum. Other means for moving the hydraulic fluid under vacuum are conceivable. The hydraulic fluid can be in a hydraulic cylinder, wherein the circulation device or the further means is arranged on a bottom side or a lateral side of the hydraulic cylinder.

An advantageous aspect of the invention provides for the degassing according to step a) to be carried out in such a way that the degassed hydraulic fluid contains a maximum of 7 vol. % air, in particular a maximum of 6 vol. % air, preferably a maximum of 5 vol. % air, preferably a maximum of 4 vol. % air. This ensures that the hydraulic fluid can absorb or dissolve an appropriate air volume.

An advantageous aspect of the invention provides for the degassed hydraulic fluid to be conveyed into the hydraulic system by means of overpressure during filling according to step b). This can ensure rapid filling and expulsion of freely moving air. If the hydraulic system is placed under vacuum, the negative pressure prevailing in the hydraulic system preferably suctions the hydraulic fluid additionally or alternatively.

An advantageous aspect of the invention provides for the degassed hydraulic fluid to be supplied to the hydraulic system by means of at least one inlet of the hydraulic system and/or to drain out at at least one outlet of the hydraulic system, in particular by means of a vacuum, during filling according to step b). Venting is thus further improved.

It is advantageous if the valves of the hydraulic system are switched to further improve the venting quality.

It is also advantageous if a pre-pressure is applied to the hydraulic system after filling according to step b). The ability to dissolve air in the hydraulic fluid is thus improved. The oil binding capacity increases proportionally with the pressure.

An advantageous aspect of the invention provides for a rinsing process to be carried out by means of the at least one inlet and the at least one outlet. The freely moving air volume in the hydraulic system is thus further reduced. The rinsing process is mainly used to clean the introduced hydraulic fluid or to clean the entire hydraulic system.

The object of the invention is also achieved by a use having the features of claim 11. The invention is directed to a use of a degassed hydraulic fluid for venting a hydraulic system, wherein in particular the hydraulic fluid contains a maximum of 7 vol. % air, in particular a maximum of 5 vol. % air, preferably a maximum of 3 vol. % air, preferably a maximum of 2 vol. % air.

The object of the invention is also achieved by a device having the features of claim 12. The invention is directed to a device for filling and venting hydraulic systems by means of a hydraulic fluid. The device comprises a first container for receiving the hydraulic fluid and having a first connection; a vacuum device fluidically connected to the first connection for applying a vacuum in the first container; a circulation device, in particular a propeller, arranged in the first container for circulating the hydraulic fluid provided in the first container. The hydraulic fluid can thus be undersaturated particularly effectively with regard to the dissolved air. Such a degassed hydraulic fluid is particularly suitable for filling hydraulic systems.

An advantageous aspect of the invention provides for the first container to be cylindrical and/or wherein a cylinder height of the cylinder and a cylinder diameter of the cylinder have a ratio in a range between 10:1 and 2:1, in particular 8:1 and 3:1, preferably 6:1 and 4:1. A vacuum is created when preparing the hydraulic fluid, i.e., during degassing. The degassed hydraulic fluid is then conveyed into the hydraulic system. The vacuum is reduced for this purpose. During this process, the hydraulic fluid is exposed to air again. In order to allow only a small amount of gassing of the hydraulic fluid, it is advantageous for the surface of the hydraulic fluid in fluidic contact with the air to be small.

An advantageous aspect of the invention provides for the first container to have a second connection, wherein the device has a conveyor fluidically connected to the second connection for conveying the hydraulic fluid from the first container into the hydraulic system. The hydraulic fluid can thus be both exposed to a vacuum and quickly conveyed into the hydraulic system. This also promotes the expulsion of freely moving air in the hydraulic system.

An advantageous aspect of the invention provides for the device to have a second container for receiving waste fluid or hydraulic fluid emptied from the hydraulic system, wherein the second container has a third connection, wherein the vacuum device for suctioning waste fluid from the hydraulic system is fluidically connected to the third connection. The waste fluid can thus also be conveyed from the hydraulic system into the second container using the vacuum device, which is also used to degas the hydraulic fluid. The second container preferably has a fourth connection to which the device and the hydraulic system can be fluidically connected. The second container is preferably located below the hydraulic system so that the waste fluid can be more easily conveyed into the second container.

The device preferably has a frame for receiving the first container and/or the second container.

The device preferably has a particle counter for evaluating hydraulic fluid purity. It is advantageous if a pressure sensor is provided on the first container and/or on the second container for determining the pressure in the first container and/or in the second container.

It is further advantageous if a saturation sensor is provided on the first container and/or on the second container for determining the air dissolved in the hydraulic fluid, in particular before and/or after applying the vacuum. Preferably, the first container and/or the second container and/or the third container are transparent.

The object of the invention is also achieved by a system having the features of claim 16. The invention is directed to a system having a hydraulic system and at least one gas collection container, wherein at free ends of the hydraulic system, in particular at the highest points in the installation position of the hydraulic system, connection points are arranged for detachably receiving the at least one gas collection container.

A gas collection container can preferably be arranged or is arranged on a fluid reservoir of the hydraulic system. The fluid reservoir in the hydraulic system usually has a low, in particular the lowest, pressure level. According to Henry's law, the solubility of gases in liquids increases with increasing pressure. The solubility of the freely moving air in the hydraulic fluid is thus lowest in the region of the fluid reservoir due to the lowest pressure level. It is therefore particularly advantageous to mount the gas collection container at said point so that the freely moving air can settle in the gas collection container. The gas collection container is preferably arranged above the pressure container, in relation to gravity. Due to the detachable arrangement of the gas collection container, the gas collection container including the damaging freely moving air can be removed from the connection point of the hydraulic system.

An advantageous aspect of the invention provides for the at least one gas collection container for testing the venting quality of the hydraulic system to be transparent, in particular at least in sections. The venting quality can thus be checked immediately after the filling process.

The invention is further directed to a hydraulic system with a connection point for receiving a gas collection container in the region of the fluid reservoir. The gas collection container can thus be positioned close to the point of lowest solubility, i.e., the low pressure level of the fluid reservoir. The connection point for the gas collection container is preferably arranged between the connection point of the fluid reservoir and the other circuit of the hydraulic system.

All descriptions of this invention referring to air can moreover also be directed exclusively to oxygen.

Further advantages, features, and details emerge from the following description, in which various exemplary embodiments of the invention are illustrated with reference to the drawing. The features mentioned in the claims and in the description may in each case be essential to the invention individually or in any desired combination.

In the drawings:

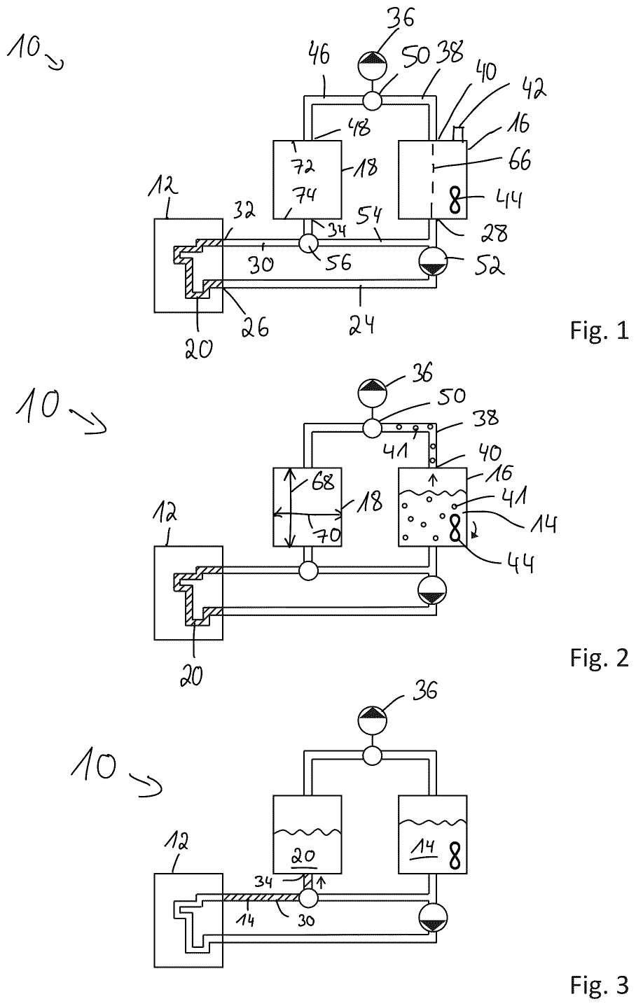

FIG. 1-6 show schematic views of a first embodiment of a device according to the invention;

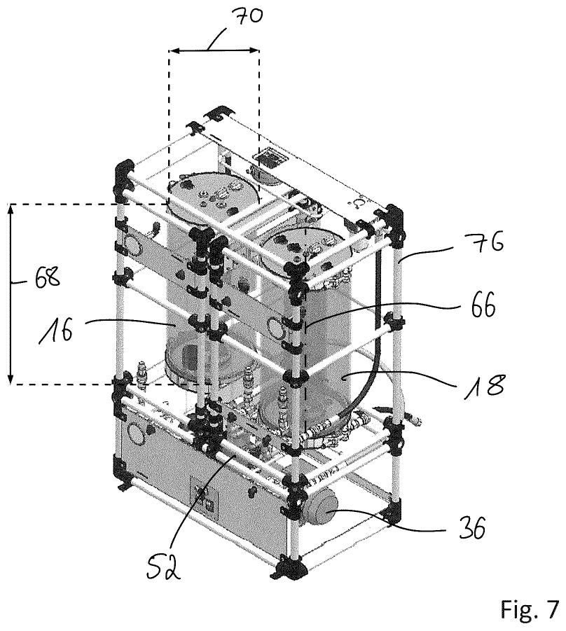

FIG. 7 shows a perspective view of a device according to the invention;

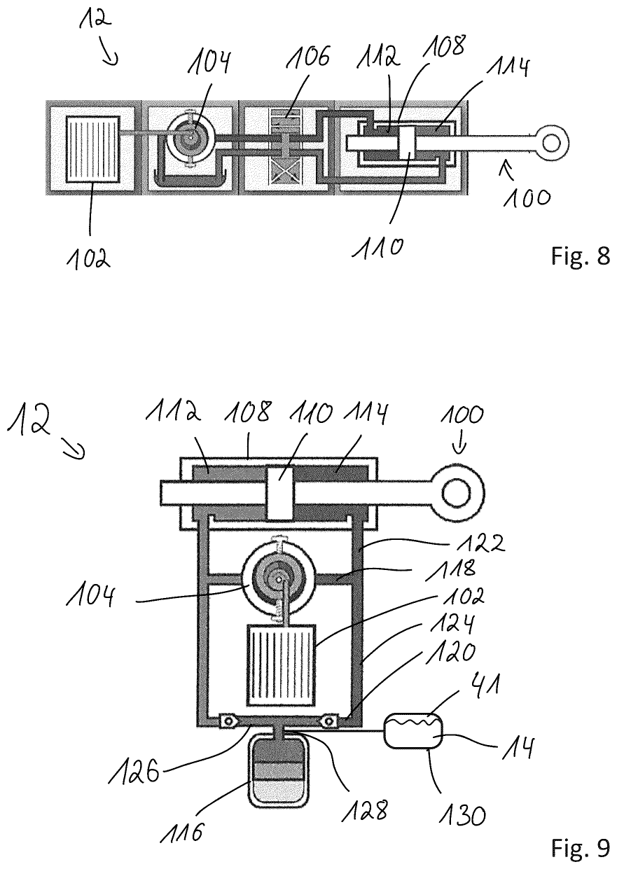

FIG. 8 shows a schematic structure of a hydraulic system for driving a linear axis;

FIG. 9 shows a schematic view of a closed hydraulic system having a gas collection container; and

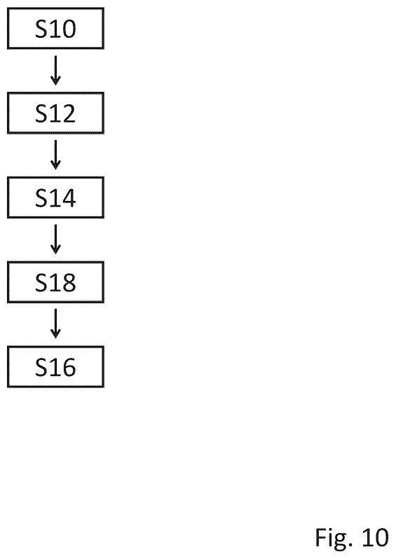

FIG. 10 shows a schematic flowchart of the method according to the invention.

The device 10 according to FIGS. 1 to 7 is configured for filling and venting a hydraulic system 12 by means of a hydraulic fluid 14. During setup, when replacing components and at regular intervals, the hydraulic fluid 14, such as hydraulic oil, is added to the hydraulic system 12. The device 10 comprises a first container 16 for processing the hydraulic fluid 14 before the filling process and a second container 18 for receiving a waste fluid 20 removed from the hydraulic system 12.

The waste fluid 20 is a hydraulic fluid 14 which was used in the hydraulic system 12 before the filling and venting process. FIG. 1 shows the state in which the first container 16 and the second container 18 are empty and the hydraulic system 12 is filled with the waste fluid 20.

The first container 16 is fluidically connected to at least one inlet connection 26 of the hydraulic system 12 by means of an inlet line 24. The inlet line 24 connects to a first container connection 28 on the container side. The second container 18 is fluidically connected to at least one outlet connection 32 of the hydraulic system 12 by means of an outlet line 30. The outlet line 30 connects to a second container connection 34 of the second container 18 on the container side.

In a first step S10 according to FIG. 10, the hydraulic fluid 14 is processed, wherein the hydraulic fluid 14 is preferably degassed under vacuum. Step S10 is also shown in FIG. 2. A negative pressure device or vacuum device 36 is provided to create a vacuum in the first container 16. The vacuum device 36 is preferably fluidically connected to a first vacuum connection 40 of the first container 16 by means of a first vacuum line 38. The vacuum device 36 is preferably designed such that the degassed hydraulic fluid 14 in the first container 16 contains a maximum of 7 vol. % air, in particular a maximum of 6 vol. % air, preferably a maximum of 5 vol. % air, preferably a maximum of 4 vol. % air. The hydraulic fluid 14 is thus undersaturated in air so that it can absorb even more air. Preferably, a first vacuum sensor 42 is provided for detecting the pressure at the first container 16, in particular in the first container 16 and/or in the first vacuum line 38.

Furthermore, a circulation device 44, in particular a motor-driven propeller, is provided in the first container 16 for circulating the hydraulic fluid 14 provided in the first container 16. The circulation device 44 preferably creates voids in the hydraulic fluid 14, at which air bubbles 41 form and can then be removed from the hydraulic fluid 14 by the applied vacuum. Degassing according to step S10 can thus be significantly accelerated. The processed hydraulic fluid 14 is then to be used for filling the hydraulic system 12. The axis of rotation of the circulation device 44 is preferably parallel or perpendicular to the vertical axis 66. A vertical arrangement of the circulation device 44, in particular of the propeller, ensures that the air bubbles 41 can rise more easily from the hydraulic fluid 14. The circulation device 44 can preferably be designed such that the rotation is pulsating so that degassing can be further accelerated.

In addition, a heating device (not shown) for heating the hydraulic fluid 14 can be provided on or in the first container 16. Degassing can thus be further accelerated.

For this purpose, according to step S12 and FIG. 3, the waste fluid 20 is conveyed from the hydraulic system 12 to the second container 18 by means of the outlet line 30. Conveyance can be carried out in such a way that the second container 18 is arranged below the hydraulic system 12 in relation to gravity and the waste fluid 20 flows from the hydraulic system 12 into the second container 18 due to the height difference. Preferably, the vacuum device 36 is fluidly connected to a second vacuum connection 48 of the second container 18 by means of a second vacuum line 46. A vacuum can be generated in the second container 18 and/or in the outlet line 30 by means of the vacuum device 36, so that the waste fluid 20 is suctioned from the hydraulic system 12 and conveyed into the second container 18.

A first valve device 50, in particular a multi-way valve, preferably a 3/2 way valve, is preferably provided for connecting and disconnecting the vacuum device 36 from the first vacuum line 38 and/or the second vacuum line 46. In a first switching position, the first valve device 50 connects the vacuum device 36 to the first container 16 or the second container 18. In a second switching position, the containers 16 and/or 18 are closed. In a third switching position, the containers 16 and/or 18 are connected to the atmosphere. Alternatively, it is conceivable that only one valve device 50 be provided for both containers 16, 18. In such case, the same condition always prevails in both containers 16, 18.

Steps S10 and S12 can also be swapped or performed simultaneously.

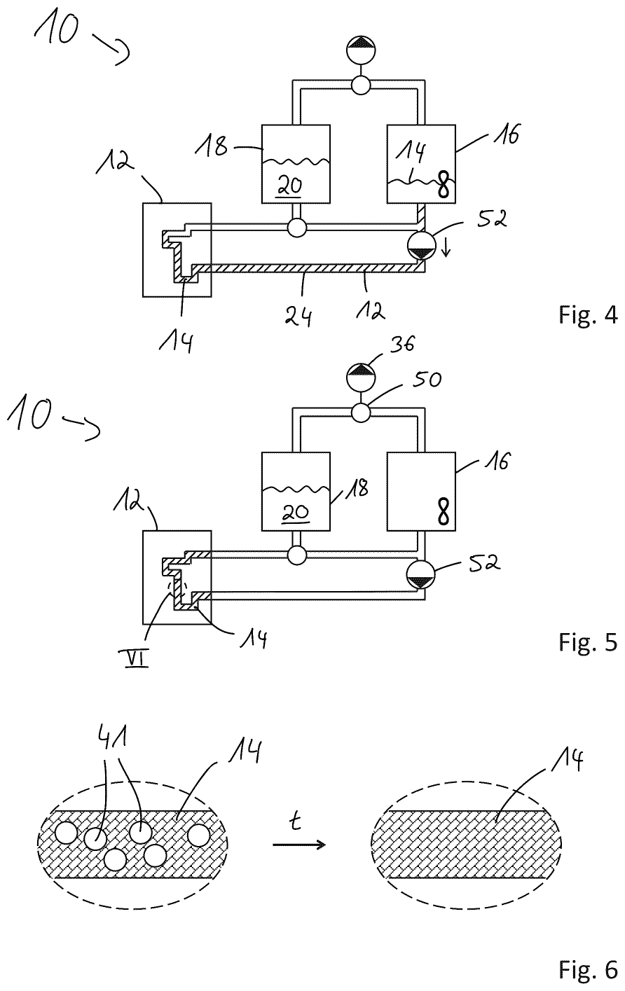

After emptying the waste fluid 20 from the hydraulic system 12, the processed and degassed hydraulic fluid 14 can be conveyed into the hydraulic system 12 according to step S14 and FIG. 4. In preparation, the hydraulic system 12 is placed under vacuum or evacuated, in particular by means of the vacuum device 36. A significant amount of air has thus already been removed from the hydraulic system 12. For conveyance, a conveyor 52, in particular a gear pump, piston pump, vane pump or diaphragm pump, is preferably provided along the inlet line 24 between the first container connection 28 and the inlet connection 26. In order for the conveyor 52 to convey the hydraulic fluid 14, atmosphere is present at the first container 16 in this step. When the hydraulic fluid 14 is filled into the hydraulic system 12 by means of pressure at the inlet connection 26, the hydraulic fluid 14 is at the same time sucked in by the prevailing negative pressure in the hydraulic system 12. Furthermore, the vacuum device 36 can at the same time suction the hydraulic fluid 14 at the outlet connection 32 by further applying the negative pressure.

The hydraulic fluid 14 drives the freely moving air remaining in the hydraulic system 12 so that it can be suctioned from the hydraulic system 12 at the outlet connection 32. Furthermore, the valves provided in the hydraulic system 12 can be switched regularly to move additional air in the hydraulic system 12 to exit from the outlet connection 32. However, freely moving air or air bubbles 41 generally remain in the hydraulic system 12, which cannot be forced out by evacuation and the hydraulic fluid 14, such as at the highest points or air pockets. Due to their compressible properties, such freely moving air or air bubbles 41 are harmful to the power transmission in the hydraulic system 12.

According to step S16 and FIG. 5, the hydraulic system 12 is filled with the degassed hydraulic fluid 14. FIG. 6a shows freely moving air in the lines of the hydraulic system 12. Due to the undersaturation of the hydraulic fluid 14, it is capable of absorbing further air, in particular the freely moving air in the lines of the hydraulic system 12, and thus venting the hydraulic system 12. Step S16 comprises an absorption period in which the degassed hydraulic fluid 14 absorbs the air freely moving in the hydraulic system 12. Subsequently, according to FIG. 6b, substantially all freely moving air in the hydraulic system 12 is absorbed by the hydraulic fluid 14. The air is still present in the hydraulic system 12, but due to its absorption in the hydraulic fluid 14 it is no longer freely moving and therefore harmless to the hydraulic system 12 and in particular to its power transmission. Subsequently, a pre-pressure can be applied in the hydraulic system 12 by means of the conveyor 52.

The absorption period is preferably at least 8 hours, in particular at least 16 hours, and/or a maximum of 48 hours, in particular a maximum of 36 hours, and preferably in the region of 24 hours.

Furthermore, according to step S18 and FIG. 5, a rinsing process can be carried out to clean the hydraulic fluid 14 and/or the hydraulic system 12 using the processed hydraulic fluid 14. Step S18 can preferably occur before step S16. The rinsing process preferably comprises conveying the hydraulic fluid 14 from the first container 16 via the inlet line 24 into the hydraulic system 12 and then back into the inlet line 24 via the outlet line 30. By means of the conveyor 52, the hydraulic fluid 14 can thus be conveyed in a circle. For this purpose, the inlet line 24 and the outlet line 30 are fluidically connected by means of a bypass line 54. Furthermore, a second valve device 56 for opening and closing the bypass line 54 can be provided in the bypass line 54. Preferably, a filter (not shown) and/or a particle counter is provided in the circuit, particularly in the bypass line 54. In order for the conveyor 52 to be able to convey the hydraulic fluid, atmosphere is present at the first container 16. The device 10 preferably further comprises filters for filtering the waste fluid 20 and/or a particle counter for detecting the degassed air from the hydraulic fluid 14 and/or the removed air from the hydraulic system 12.

Alternatively, a separate vacuum device 36 can be provided for each of the first container 16 and the second container 18. In such case, the third valve device 64 can preferably be omitted.

The outlet line 30 can further comprise another valve device for connecting the hydraulic system 12 to the first container 16 or to the second container 18 22 in three switching positions.

After the filling and venting process, the connections are blocked.

Due to the venting quality resulting from the degassed hydraulic fluid 14, the hydraulic system 12 and the driven linear axis 100 can remain installed, for example. Complex rotation of the hydraulic system 12 is no longer necessary.

The first container 16 and/or the second container 18 are preferably designed as cylinders with a circular cross-section. The first container 16 and/or the second container 18 preferably extend along a vertical axis 66, wherein preferably a cylinder height 68 running parallel to the vertical axis 66 and a cylinder diameter 70 running perpendicular to the vertical axis 66 are at a ratio in a range between 10:1 and 2:1, in particular 8:1 and 3:1, preferably 6:1 and 4:1. Such a ratio is particularly advantageous because, on the one hand, the hydraulic fluid 14 can be effectively degassed and, on the other hand, when the hydraulic fluid 14 is conveyed to the hydraulic system 12, only a small surface interacts with air due to the small cross-section. Preferably, the first container 16 and/or the second container 18 have an upper side 72 and an underside 74 that are opposite along the vertical axis 66. Preferably, the first container connection 28 is arranged on the underside 74 or upper side 72 of the first container 16 and/or the first vacuum connection 40 is arranged on the underside 74 or upper side 72 of the first container 16. Preferably, the second container connection 34 is arranged on the underside 74 or upper side 72 of the second container 18 and/or the second vacuum connection 48 is arranged on the underside 74 or upper side 72 of the second container 18. The circulation device 44 is preferably arranged on the inside of the underside 74 of the first container 16.

The first container 16 and/or the second container 18 are completely or partially transparent for inspection purposes.

According to FIG. 7, the device 10 preferably has a frame 76 for receiving the first container 16 and/or the second container 18 and/or the vacuum device 36 and/or the conveyor 52. The device 10 is designed such that it can be mounted and removed in a modular manner. This means it can be easily transported to the customer. For this purpose, the frame 76 is preferably designed in several parts, wherein at least a first section of the frame 76 receives the containers and at least a second section of the frame 76 receives the vacuum device 36 and the conveyor 52.

FIG. 8 shows an example of a structure of a hydraulic system 12 for driving a linear axis 100. A motor 102, a pump 104 with a reservoir for the hydraulic fluid 14, a valve device 106 and a hydraulic cylinder 108 with a piston 110 are provided for this purpose. Preferably, the piston 110 is rigidly connected to the linear axis 100. The piston 110 divides the hydraulic cylinder 108 into a first hydraulic chamber 112 and a second hydraulic chamber 114.

FIG. 9 shows the structure of a closed hydraulic system 12, wherein additionally an, in particular pre-loaded, fluid reservoir 116 is provided for providing hydraulic fluid 14 when the first hydraulic chamber 112 and the second hydraulic chamber 114 are pressurized. The fluid reservoir 116 preferably has a fluidically separated gas pocket. The fluid reservoir 116 is preferably arranged parallel to the pump 104. The first hydraulic chamber 112 and the second hydraulic chamber 114 are preferably fluidically connected via a first line 118, in which the pump 104 is arranged, and a second line 120, on which the fluid reservoir 116 is arranged. When the first hydraulic chamber 112 is pressurized, a first pressure level 122 prevails in the first line 118 and the second line 120 at the end nearest the first hydraulic chamber 112 and a second pressure level 124 prevails at the end nearest the second hydraulic chamber 114. In addition, switching valves are provided in the region of the pre-pressure chamber so that a third pressure level 126 is present in the region of the second line 120. In such case, the first pressure level 122 is greater than the second pressure level 124, and the second pressure level 124 is greater than the third pressure level 126.

In a semi-closed or semi-open hydraulic system 12 (not shown), a leakage fluid line is fluidically connected to a fluid tank, wherein the fluid tank is exposed to the atmosphere. However, the leakage fluid line is dimensioned so small compared to the drive lines that no significant venting takes place via the leakage fluid line.

According to FIG. 9, the closed hydraulic system 12 further comprises a connection point 128 in the region of the fluid reservoir 116 for receiving a gas collection container 130. The connection is preferably located in the region of the second line 120 in which the low third pressure level 126 is present. The fluid binding capacity, in particular the oil binding capacity, increases proportionally to the pressure. If air were to separate from the hydraulic fluid 14, this would most likely occur in the region of the lowest pressure level, i.e., in the region of the third pressure level 126. The connection point 128 is preferably designed such that the gas collection container 130 constitutes the highest point in the region of the third pressure level 126. Accordingly, freely moving air bubbles 41 will settle in the gas collection container 130. The gas collection container 130 is preferably transparent, in particular at least in sections, so that the amount of freely moving air can be seen for the purposes of inspecting the venting quality of the hydraulic system 12. The gas collection container 130 is furthermore designed to be detachable from the connection point 128, so that the freely moving air that has settled in the gas collection container 130 can be removed from the hydraulic system 12.

A system according to the invention preferably comprises a hydraulic system 12 with a connection point 128 and at least one gas collection container 130. Alternatively, the connection point 128 and/or the gas collection container 130 can be used on a semi-closed or open hydraulic system 12.

List of reference signs

| | |
|---|---|
| 10 | device |
| 12 | hydraulic system |
| 14 | hydraulic fluid |
| 16 | first container |
| 18 | second container |
| 20 | waste fluid |
| 24 | inlet line |
| 26 | inlet connection |
| 28 | first container connection |
| 30 | outlet line |
| 32 | outlet connection |
| 34 | second container connection |
| 36 | vacuum device |
| 38 | first vacuum line |
| 40 | first vacuum connection |
| 41 | air bubbles |
| 42 | vacuum sensor |
| 44 | circulation device |
| 46 | second vacuum line |
| 48 | second vacuum connection |
| 50 | first valve device |
| 52 | conveyor |
| 54 | bypass line |
| 56 | second valve device |
| 66 | vertical axis |
| 68 | cylinder height |
| 70 | cylinder diameter |
| 72 | upper side |
| 74 | underside |
| 76 | frame |
| 100 | linear axis |
| 102 | motor |
| 104 | pump |
| 106 | valve device |
| 108 | hydraulic cylinder |
| 110 | piston |
| 112 | first hydraulic chamber |
| 114 | second hydraulic chamber |
| 116 | fluid reservoir |
| 118 | first line |
| 120 | second line |
| 122 | first pressure level |
| 124 | second pressure level |
| 126 | third pressure level |
| 128 | connection point |
| 130 | gas collection container |

1. A method for filling and venting hydraulic systems by a hydraulic fluid, comprising the steps of:
a) degassing the hydraulic fluid by applying a vacuum; and
b) filling the hydraulic system with the degassed hydraulic fluid.

2. The method according to claim 1, further including:
c) venting the hydraulic system by absorbing the air that is freely moving in the hydraulic system using the degassed hydraulic fluid.

3. The method according to claim 1, further including:
d) before filling according to step b): emptying waste fluid from the hydraulic system by suctioning waste fluid from the hydraulic system, and/or evacuating the hydraulic system by applying a vacuum.

4. The method according to claim 3, wherein emptying waste fluid according to step d) is carried out by applying a vacuum in such a way that a maximum of 6 vol. % of freely moving air remains in the hydraulic system.

5. The method according to claim 1, wherein the hydraulic system is designed to be open, semi-open or closed.

6. The method according to claim 1, wherein the hydraulic fluid is circulated by a circulation device during degassing according to step a).

7. The method according to claim 1, any of the preceding claims, wherein degassing according to step a) is carried out in such a way that the degassed hydraulic fluid contains a maximum of 6 vol. % air.

8. The method according to claim 1, wherein the degassed hydraulic fluid is conveyed into the hydraulic system by overpressure during filling according to step b).

9. The method according to claim 1, wherein the degassed hydraulic fluid is supplied to the hydraulic system by at least one inlet connection of the hydraulic system and/or drains out at at least one outlet connection of the hydraulic system during filling according to step b).

10. The method according to claim 9, wherein a rinsing process is carried out through the at least one inlet connection and the at least one outlet connection.

11. (canceled)

12. A device for filling and venting hydraulic systems by of a hydraulic fluid, the device comprising:
a first container for receiving the hydraulic fluid and having a first vacuum connection;
a vacuum device fluidically connected to the first vacuum connection for applying a vacuum in the first container; and
a circulation device arranged in the first container for circulating the hydraulic fluid provided in the first container.

13. The device according to claim 12, wherein the first container is cylindrical and/or wherein a cylinder height of the cylinder and a cylinder diameter of the cylinder have a ratio in a range between 10:1 and 2:1, in particular 8:1 and 3:1, preferably 6:1 and 4:1.

14. The device according to claim 12, wherein the first container has a first container connection, wherein the device has a conveyor fluidically connected to the first container connection for conveying the hydraulic fluid from the first container into the hydraulic system.

15. The device according to claim 12, wherein the device has a second container for receiving waste fluid emptied from the hydraulic system, wherein the second container has a second container connection, wherein the vacuum device for suctioning waste fluid from the hydraulic system is fluidically connected to the second container connection.

16. A system having a hydraulic system and at least one gas collection container, wherein at free ends of the hydraulic system, in particular at the highest points in the installation position of the hydraulic system, and/or in the region of a fluid reservoir connection points are arranged for detachably receiving the at least one gas collection container.

17. The system according to claim 16, wherein the at least one gas collection container for testing the venting quality of the hydraulic system, is transparent, in particular at least in sections.
